(19) United States
(12) Patent Application Publication
(10) Pub. No.: US 2024/0204378 A1
(43) Pub. Date: Jun. 20, 2024

(54) Battery Cell Having an Electrical Fuse

(71) Applicant: Bayerische Motoren Werke Aktiengesellschaft, Munchen (DE)

(72) Inventors: Wonsup HAN, Suwon-Si, Kwonsun-Ku (KR); Hyunchul ROH, Muenchen (DE); Nina ZENSEN, Pfaffenhofen an der Ilm (DE)

(21) Appl. No.: 18/286,798

(22) PCT Filed: Apr. 12, 2022
(86) PCT No.: PCT/EP2022/059672

§ 371 Date: Oct. 13, 2023

(30) Foreign Application Priority Data
Apr. 16, 2021 (DE) 10 2021 109 628.6

(51) Int. Cl. H01M 50/583; H01H 85/36; H01M 10/0525

(52) U.S. Cl. CPC H01M 50/583; H01H 85/36; H01M 10/0525; H01M 2200/103; H01M 2220/20

(57) ABSTRACT

A battery cell has an electrical fuse that is a safety fuse having a groove or an opening. An expansion material is arranged in the groove or the opening and has a higher coefficient of thermal expansion than the material of the safety fuse.

### BACKGROUND AND SUMMARY

The invention relates to a battery cell having an electrical fuse, in particular a battery cell for a high-voltage battery.

Electrically powered motor vehicles such as electric vehicles, hybrid vehicles or plug-in hybrid vehicles employ high-voltage batteries which typically comprise one or more battery modules, each comprising a plurality of battery cells. Due to the achievable high energy density, motor vehicles especially employ lithium-ion batteries. Here and hereinbelow the term “lithium-ion battery” is used synonymously with all designations for lithium-containing galvanic elements and cells commonly used in the prior art, for example lithium battery, lithium cell, lithium-ion cell, lithium polymer cell and lithium-ion accumulator. Rechargeable batteries (secondary batteries) are especially included. The terms “battery” and “electrochemical cell” are also used synonymously with the term “lithium-ion battery”. The lithium-ion battery may also be a solid-state battery, for example a ceramic or polymer-based solid-state battery.

In the case of a mechanical impact onto the battery cell which may bring about for example a deformation and/or penetration of a sharp object into the battery cell, there may be a risk of an electrical shorting of the electrodes. Exothermic electrode reactions brought about for example due to a shorting of the electrodes, can liberate heat which can result in overheating of the battery cell. This can result in thermal runaway of the battery cell. In a battery module comprising a plurality of battery cells the thermal runaway of one battery cell can result in spreading of the overheating to the adjacent battery cells, thus presenting a risk of damage to the entire battery module or even the entire high-voltage battery if this is not prevented by suitable safety measures.

Published specification DE 10 2013 204 341 A1 describes a safety element for a battery cell. The battery cell contains a melting fuse arranged inside the battery cell housing between the positive terminal and the current collector assigned to the positive terminal.

It is an object of the present invention to provide an improved battery cell having an electrical fuse, wherein the battery cell features a further increase in safety and a reduced risk of thermal runaway.

This object is achieved by a battery cell according to the claimed invention.

In one embodiment of the invention the battery cell has an electrical fuse, wherein the electrical fuse is a melting fuse. The melting fuse has a groove or an opening, wherein an expansion material is arranged in the groove or the opening. An “expansion material” is here and hereinbelow to be understood as meaning a material having a greater coefficient of thermal expansion than the material of the melting fuse.

The invention is especially based on the following considerations: The melting fuse is provided to interrupt the electrical circuit of the battery cell in the case of an excessively high current. Conventional melting fuses require a very high current, for example a current of more than 600 A, to heat the material of the melting fuse to above its melting point so that destruction of the melting fuse results in interruption of the electrical circuit. In the battery cell described herein, destruction of the melting fuse is aided by the expansion material having a greater coefficient of thermal expansion than the material of the melting fuse. The expansion material is arranged in an opening or groove of the melting fuse. This opening or groove is a mechanically unstable region which upon expansion of the expansion material functions as an intended breaking point. Operation of the melting fuse can therefore be effected or at least aided by the mechanical forces of the expansion material acting during a temperature increase. This increases the reliability of the melting fuse. Furthermore, lower currents can advantageously be sufficient to bring about operation of the melting fuse. This increases the safety of the battery cell.

In one embodiment the melting fuse is electrically conductively connected to the current collector of the positive electrode of the battery cell. The current collector of the positive electrode (cathode) of the battery cell may for example comprise or consist of aluminum. The arrangement of the melting fuse on the current collector of the positive electrode has the advantage that the material used for the melting fuse may be aluminum which has a lower melting point than the material typically used as the current collector of the negative electrode, namely copper.

The melting fuse is preferably an integral constituent of the current collector of the positive electrode of the battery cell. The melting fuse may in particular be in the form of an opening or groove in the current collector. In the region of the opening or groove the electrical resistance of the current collector is increased due to the reduction in the cross sectional area brought about by the opening or groove. This region of the current collector therefore undergoes marked heating at high currents and can thus operate the melting fuse.

The melting fuse is preferably formed from a metal or a metal alloy. It is preferable when the melting fuse comprises or consists of aluminum. When the melting fuse is an integral constituent of the positive current collector the current collector preferably comprises or consists of aluminum.

In at least one embodiment the expansion material comprises a metal, a polymer or a ceramic. Suitable metals, polymers or ceramics are those whose coefficient of thermal expansion is greater than that of the material of the melting fuse, for example aluminum. Furthermore, the expansion material is advantageously thermally stable up to at least 100° C., preferably even up to 600° C. The expansion material may in particular comprise or consist of polyvinyl chloride (PVC), polytetrafluoroethylene (PTFE) or cellulose acetate (CA).

In one configuration the expansion material may be a material which exhibits anisotropic longitudinal elongation during a temperature increase. This allows the expansion material to generate mechanical stress in a preferential direction. Suitable materials with anisotropic longitudinal elongation include for example (semi)crystalline n-alkanes (for example paraffins). A hard paraffin may especially be employed on account of its elevated softening temperature. A number of PE types are also suitable, in particular high-density polyethylene (HDPE, softening temperature about 145° C.). Fiber reinforced plastics such as carbon fiber reinforced plastics (CFRP) or glass fiber reinforced plastics (GFRP), where thermal expansion is typically greater in the fiber direction than perpendicular to the fiber direction, are also suitable.

In an advantageous configuration the expansion material is provided with a cover. The cover may advantageously prevent a chemical reaction of the expansion material with the electrolyte and/or other constituents of the battery cell. Accordingly, the material selected for the cover is one that does not react with the electrolyte and/or other constituents of the battery cell. The cover especially comprises or consists of a polymer. Employable polymers include for example those materials that are also suitable as the separator. Suitable polymers are for example polyethylene (PE), polypropylene (PP), polyethylene terephthalate (PET) or polyimide (PI).

Also proposed are a lithium-ion battery comprising a plurality of the battery cells described herein and a motor vehicle comprising such a lithium-ion battery. The battery cell described herein may, due to its improved safety, advantageously be used in a lithium-ion battery which may in particular be employed as a traction battery in an electrically propelled motor vehicle.

A preferred exemplary embodiment of the invention is described below with reference to the figures. Further details, preferred embodiments and developments of the invention are apparent therefrom.

### BRIEF DESCRIPTION OF THE DRAWINGS

FIG. 1 is a schematic perspective representation of a housing of the battery cell according to an exemplary embodiment.

FIG. 2 is a schematic perspective representation of the current collector of the positive electrode of the battery cell according to an exemplary embodiment.

FIG. 3 is an enlarged perspective view of the region of the melting fuse.

FIG. 4 is a schematic representation of the region of the melting fuse in cross section.

### DETAILED DESCRIPTION OF THE DRAWINGS

Identical or identically acting constituents are each provided with identical reference numerals in the figures. The constituents shown and the size ratios of the constituents relative to one another are not to scale.

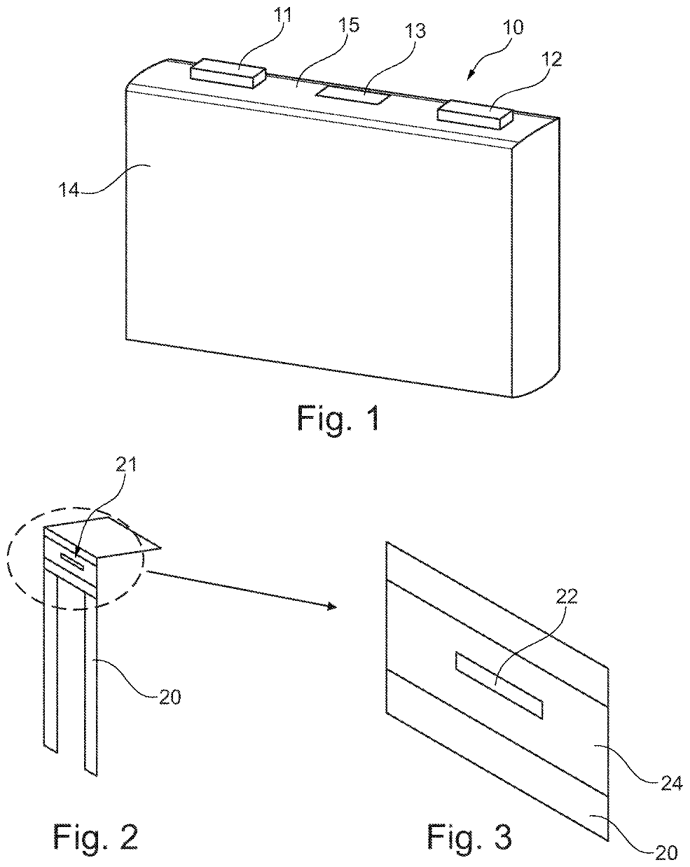

In the present exemplary embodiment the battery cell 10 schematically represented in FIG. 1 is a prismatic battery cell 10. Other configurations of the battery cell are alternatively also possible, for example the battery cell 10 may be in the form of a cylindrical cell.

The battery cell 10 has a housing 14 which forms a mechanically resistant shell for the electrode unit of the battery cell 10 arranged therein. The electrode unit may for example be in the form of an electrode stack or electrode winding. In the exemplary embodiment the housing 14 has a rectangular base area and is substantially cuboidal. The housing 14 may for example have a floor, side walls and a cap 15. Prismatic battery cells 10 may advantageously be easily stacked and assembled into a battery module.

The housing 14 may be formed from a metal or a metal alloy, preferably from aluminum. The housing 14 may at least in regions have an electrically insulating coating. The battery cell 10 has a positive terminal 11 and a negative terminal 12, wherein the terminals 11, 12 are arranged for example on the cap 15 of the housing 14. The terminals 11, 12 form the external electrical connections of the battery cell 10 and are each electrically conductively connected to a current collector of an electrode. FIG. 1 further shows a cover 13 arranged on the cap 15 of the housing which is arranged for example in the region between the electrical terminals 11, 12. The cover 13 may have an excess pressure safety device, such as for example a bursting membrane, arranged below it.

FIG. 2 shows the current collector 20 of the positive pole (cathode) of the battery cell 10. The current collector 20 is connected to at least one current conductor of a positive electrode of the battery cell 10 and makes the connection to the positive terminal 11 on the housing 14. The current collector comprises a melting fuse 21. The melting fuse 21 protects the battery cell from excessively high currents, especially in the case of a shorting of the electrodes. Such a shorting of the electrodes may for example result from deformation of the housing 14 or penetration of a sharp object into the housing 14 in the event of an accident for instance.

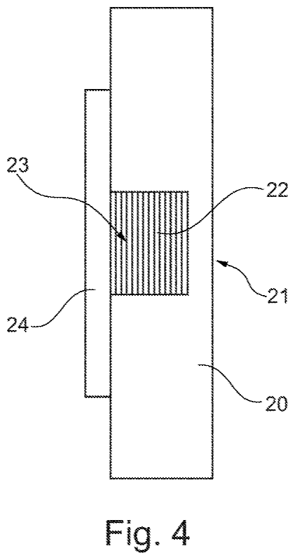

In FIGS. 3 and 4 the melting fuse 21 is shown in a perspective view and in cross section. The melting fuse 21 is formed by a region of the current collector 20 which has a groove 23 or alternatively an opening. The groove 23 or an opening locally reduces the cross sectional area of the current collector 20 with the result that this region undergoes melting due to severe heating at high currents and thus functions as a melting fuse. The current collector 20 and the region of the groove 23 forming the melting fuse 21 comprise or consist of aluminum for example.

The groove 23 has an expansion material 22 arranged in it. The expansion material 22 has a greater coefficient of thermal expansion than the material of the melting fuse 21, for example aluminum. The expansion material 22 comprises a metal, a polymer or a ceramic for example. The expansion material may in particular comprise or consist of polyvinyl chloride (PVC), polytetrafluoroethylene (PTFE) or cellulose acetate (CA). In the case of a temperature increase the expansion material 22 generates mechanical stress in the region of the melting fuse 21. In the case of a temperature increase the operation of the melting fuse 21 may be effected by the melting and/or by mechanical destruction due to the mechanical stress generated by the expansion material. These effects may especially be cooperative and thus increase the reliability of the melting fuse. The critical current at which the melting fuse is operated may advantageously be reduced by the expansion material. In a conventional melting fuse the critical current may be about 600 A to 800 A for example.

The melting fuse may for example be configured such that a charging or discharging current having a C-rate of at least 7 C, at least 8 C or even at least 10 C is tolerated. A C-rate of 1 C is the current required to charge or discharge the cell in one hour. The melting fuse may be configured such that it interrupts the electrical circuit at a critical C-rate in the range from 15 C to 50 C.

The expansion material 22 is advantageously a material exhibiting anisotropic thermal elongation, in particular the thermal elongation perpendicular to the longitudinal direction of the groove 23 may be greater than parallel to the longitudinal direction of the groove 23. In this case the expansion material 22 comprises for example a hard paraffin, a high density polyethylene (HDPE) or a fiber-reinforced plastic with anisotropic longitudinal elongation.

The expansion material 22 is preferably provided with a cover 24. The cover 24 may be provided to protect the expansion material 22 from chemical reactions with the electrolyte and/or other constituents of the battery cell 10 and preferably comprises a polymer that does not react with the employed electrolyte. The cover 24 may for example comprise or consist of polyethylene (PE), polypropylene (PP), polyethylene terephthalate (PET) or polyimide (PI).

Although the invention has been illustrated and described in detail using exemplary embodiments the invention is not limited by the exemplary embodiments. On the contrary, other variations of the invention may be derived therefrom by a person skilled in the art without departing from the scope of protection of the invention defined by the claims.

### LIST OF REFERENCE NUMERALS

10 Battery cell
11 Positive terminal
12 Negative terminal
13 Cover for bursting membrane
14 Housing
15 Cap
20 Current collector
21 Melting fuse
22 Expansion material
23 Groove
24 Cover

1.-10. (canceled)

11. A battery cell comprising:
an electrical fuse, wherein:
the electrical fuse is a melting fuse which has a groove or an opening, and
an expansion material having a greater coefficient of thermal expansion than a material of the melting fuse is arranged in the groove or the opening.

12. The battery cell according to claim 11,
wherein the melting fuse is electrically conductively connected to a current collector of a positive electrode of the battery cell.

13. The battery cell according to claim 12,
wherein the melting fuse is an integral constituent of the current collector of the positive electrode of the battery cell.

14. The battery cell according to claim 11,
wherein the melting fuse comprises aluminum.

15. The battery cell according to claim 11,
wherein the expansion material comprises a metal, a polymer or a ceramic.

16. The battery cell according to claim 11,
wherein the expansion material comprises polyvinyl chloride, polytetrafluoroethylene or cellulose acetate.

17. The battery cell according to claim 11,
wherein the expansion material exhibits an anisotropic coefficient of thermal expansion.

18. The battery cell according to claim 17,
wherein the expansion material comprises a hard paraffin, a polyethylene, a high-density polyethylene or a fiber reinforced plastic.

19. The battery cell according to claim 11,
wherein the expansion material is provided with a cover.

20. A lithium-ion battery comprising two or more battery cells according to claim 11.
